(19) United States
(12) Patent Application Publication
(10) Pub. No.: US 2024/0249851 A1
(43) Pub. Date: Jul. 25, 2024

(54) MOLTEN SALT REACTOR AND PASSIVE FUEL INJECTION METHOD THEREFOR

(71) Applicant: Korea Advanced Institute of Science and Technology, Daejeon (KR)

(72) Inventors: Yonghee KIM, Daejeon (KR); Taesuk OH, Daejeon (KR); Eunhyug LEE, Daejeon (KR)

(21) Appl. No.: 18/016,923

(22) PCT Filed: Oct. 6, 2022
(86) PCT No.: PCT/KR2022/015056

§ 371 Date: Jan. 19, 2023

(30) Foreign Application Priority Data
Dec. 16, 2021 (KR) 10-2021-0180216
Sep. 16, 2022 (KR) 10-2022-0117142

(51) Int. Cl. G21C 3/54; G21C 1/02; G21C 3/24; G21C 5/12

(52) U.S. Cl. CPC G21C 3/54; G21C 1/022; G21C 3/24; G21C 5/12

(57) ABSTRACT

Disclosed herein are a molten salt reactor and a passive fuel injection method therefor, wherein the molten salt reactor includes an active core part and a blanket part, wherein the active core part is disposed to define a liquid-liquid interface with an upper portion of the blanket part having a liquid metal phase, and a fissile fuel is passively supplied from a lower blanket part to an upper active core part through the liquid-liquid interface, and a fertile fuel is passively supplied from the upper active core to the lower blanket part, and a passive fuel injection method using the same.

### BACKGROUND OF THE INVENTION

### 1. Field of the Invention

The present disclosure relates to a molten salt reactor and a passive fuel injection method therefor.

### 2. Description of the Related Art

A nuclear reactor is a device that produces a certain amount of energy through a controlled nuclear reaction and has been developed in the direction of strengthening safety and the economy over three generations. Recently, research and development of safer and more sustainable, so-called fourth-generation reactors are being actively conducted, and one of the reactors is a molten salt reactor (MSR), which is receiving a lot of attention. The MSR refers to a nuclear reactor that uses salt-substituted fuel as a nuclear fuel and coolant by dissolving the salt-substituted fuel into molten salt at a high temperature. The MSR usually uses fluorine (F) or chlorine (Cl)-based salt as a solvent, and an alloy material such as Hastelloy-N, which has strong corrosion resistance, is mainly used as a structural material. Since the molten salt reactor operates at near atmospheric pressure and uses a molten core, the possibility of so-called serious accidents is low enough to be ruled out, and there is no risk of hydrogen explosion because hydrogen gas is not generated in any case. In addition, the MSR has the advantages of lenient residual decay heat removal during emergencies and a strong negative feedback effect stemming from the thermal expansion that contributes to superior inherent safety features.

The most well-known MSR precedent research for MSR is the Molten Salt Research Experiment (MSRE) conducted at the Oak Ridge National Laboratory (ORNL) in the United States in the 1960s, which was a thermal neutron spectrum MSR exploiting thorium-based fuel cycle. The MSRE utilized the concept of real-time online fuel reprocessing to maintain criticality during operation, which is a very sensitive technology in terms of nuclear breeding resistance that renders commercial deployment unfeasible. In addition, since a replacement cycle of graphite moderator used to secure the thermal neutron spectrum is as short as about 5 years, it additionally causes limitations related to replacement cost and graphite radioactive waste. Therefore, research on a fast spectrum-based molten salt fast reactor (MSFR) having a high conversion ratio (CR) while excluding a moderator is being actively conducted.

In the case of the fast spectrum MSFR, to maximize the fuel conversion cost, a blanket provided as fertile fuel (convertible fuel) such as U-238 is used, and FIG. 1 is a conceptual view simply illustrating the structure of the MSFR in which the blanket is installed in a radial direction. A reactor vessel is a simplified cylindrical shape as a whole and it is surrounded by the reflector residing outside of an active core filled with liquid fuel to enhance neutron economy. A heat exchanger connected to the active core is located outside the reflector, and molten salt fuel circulates between the active core and the heat exchanger. In the case of the MSFR using the blanket as illustrated in FIG. 1, it is necessary to separate fissile nuclear fuel bred in the blanket online to inject the fissile nuclear fuel into an active core of the molten salt fuel system. However, since a corresponding online fuel reprocessing process is a very sensitive technology in terms of nuclear breeding resistance, it is difficult to commercialize the MSFR, and deterioration of system complexity due to the reprocessing process accompanies the limitation of economic degradation, making it difficult to secure sufficient competitiveness as a next-generation nuclear reactor. Therefore, to develop the MSFR with high competitiveness, a new method is required to inject fuel grown in the blanket into the active core in an extremely simple and 100% reliable passive manner without online reprocessing.

For example, Korean Patent Publication No. 10-2014-0123089 discloses a technology related to an integrated molten salt reactor, specifically, a nuclear power plant. The nuclear power plant includes: a molten salt reactor (MSR) generating heat; a heat exchanger system; a radiation detector disposed outside a vessel; a shutoff mechanism disposed outside the vessel; and an end-use system. Here, the MSR includes a vessel, a graphite moderator core disposed in the vessel, and at least molten salt circulating in the vessel, the molten salt transfers heat generated by the MSR to the heat exchanger system, the graphite moderator core defines one or more through-holes, the heat exchanger system receives heat generated by the MSR and provides the received heat to the end-use system, the heat exchanger system includes a plurality of heat exchangers in fluid communication with the one or more through-holes in the graphite moderator core, each of the heat exchangers is associated with a respective radiation detector, the radiation detectors are arranged to detect radioactivity present in the coolant salt circulating in the heat exchangers, respectively; and when the shutoff mechanism detects radioactivity in excess of a threshold by the radiation detector in the heat exchanger, the radiation detectors are arranged to block circulation of the coolant salt circulating in the heat exchangers. However, the nuclear power plant has a limitation in that the online molten salt reprocessing process has to be performed, and the graphite moderator has to be replaced, for example, every 5 years.

Thus, the inventors of the present invention studied the molten salt reactor capable of high efficiency and a stable long-term operation without the need to perform the online molten salt reprocessing process in the molten salt reactor, and the passive fuel injection method used therein to complete the present invention.

### SUMMARY OF THE INVENTION

Embodiments of the present invention are directed to provide a molten salt reactor and a passive fuel injection method therefor.

According to an aspect of the present invention, there is a provision of the molten salt reactor including an active core part and a blanket part, wherein the active core part is disposed to define a liquid-liquid interface with an upper portion of the blanket part having a liquid metal phase, and a fissile fuel is passively supplied from a lower blanket part to an upper active core part through the liquid-liquid interface, and a fertile fuel is passively supplied from the upper active core to the lower blanket part.

Here, the fissile fuel generated through the natural circulation inside the lower blanket part may move to the liquid-liquid interface.

According to another aspect of the present invention, there is provided with a passive fuel injection method including: generating neutrons due to nuclear fission occurring in an active core part of the molten salt reactor; allowing the generated neutrons to move to a blanket part through a liquid-liquid interface; absorbing the neutrons moving to the blanket part into a fertile fuel to generate a fissile fuel inside the blanket part; allowing the generated fissile fuel to move to the liquid-liquid interface through natural circulation inside the blanket part; allowing the fissile fuel moving to the liquid-liquid interface due to the natural circulation to move the active core part through the liquid-liquid interface; and supplying the fertile fuel from the active core part to the blanket part through the liquid-liquid interface.

### Advantageous Effect

According to the present invention, it may be possible to operate the molten salt reactor with high efficiency and stably for a long period without performing the molten salt reprocessing process, and there may be the advantage in being able to be applied to the molten salt reactor having the various structures.

### BRIEF DESCRIPTION OF THE DRAWINGS

FIG. 1 is a conceptual view of a fast molten salt reactor in which a general blanket concept is used;

FIG. 2 is a conceptual view illustrating a molten salt reactor according to an embodiment of the present invention;

FIG. 3 is a schematic view illustrating a reaction in which plutonium and uranium are substituted at a liquid-liquid interface according to a method of the present invention;

FIG. 4 is a comparative graph illustrating a change in reactor reactivity when the molten salt reactor and the fuel injection method are used according to the present invention;

FIG. 5 is a conceptual view illustrating an example in which a structure of the present invention is applied to a stable salt reactor (SSR);

FIG. 6 is a phase diagram illustrating a mixture of uranium and iron;

FIG. 7 is a phase diagram illustrating a mixture of plutonium and iron;

FIG. 8 is a phase diagram illustrating a mixture of KCl and UCl₃;

FIG. 9 is a phase diagram illustrating a mixture of NaCl and UCl₃;

FIG. 10 is a conceptual view illustrating the specifications of a reactor for performing an experiment that confirms reactivity depending on a substitution ratio of plutonium and uranium in the molten salt reactor according to the present invention;

FIG. 11 is a conceptual view illustrating a molten salt reactor according to another embodiment of the present invention; and

FIG. 12 is a conceptual view illustrating a molten salt reactor according to further another embodiment of the present invention.

### DESCRIPTION OF THE PREFERRED EMBODIMENTS

The present invention provides a molten salt reactor.

A ‘blanket’ and ‘blanket part’ used in the present invention includes a configuration that receives neutrons from an active core while containing, for example, U-238 as a fertile fuel and supplies the U-238 to the active core through natural circulation inside the blanket and also a configuration that substitutes Pu-239 with uranium in the active core to the Pu-239 to the active core while containing, for example, Pu-239, as a fissile fuel from the beginning.

More specifically, the present invention provides a molten salt reactor including an active core part and a blanket part. In the molten salt reactor, the active core part is disposed to form a liquid-liquid interface with an upper portion of the blanket part having a liquid metal phase, a fissile fuel is passively supplied from the lower blanket part to an upper active core part through the liquid-liquid interface, and a fertile fuel is passively supplied from the upper active core to the lower blanket part.

Hereinafter, the molten salt reactor of the present invention will be described in detail for each configuration.

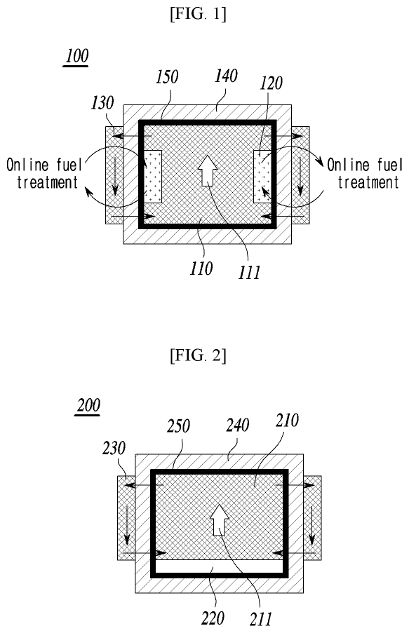

The existing fast molten salt reactor has a structure in which a blanket is installed in a radial direction of the reactor as illustrated in FIG. 1, and a molten salt fuel circulates back and forth between the active core and the heat exchanger. The existing molten salt reactor requires a process of separating fissile nuclear fuel bred in the blanket in online and injecting the fissile nuclear fuel into an active core molten salt fuel system, which is a very sensitive technology in terms of breeding resistance, and thus, it is difficult to be applied to a commercial system for deployment. The present invention is an invention to solve such a limitation.

The present invention is a molten salt reactor including an active core provided as a molten salt fuel and a blanket part that is in a liquid metal state, and functions performed by the active core part and the blanket part of the present invention are the same as the functions performed by the active core part and the blanket part in a typical fast molten salt reactor.

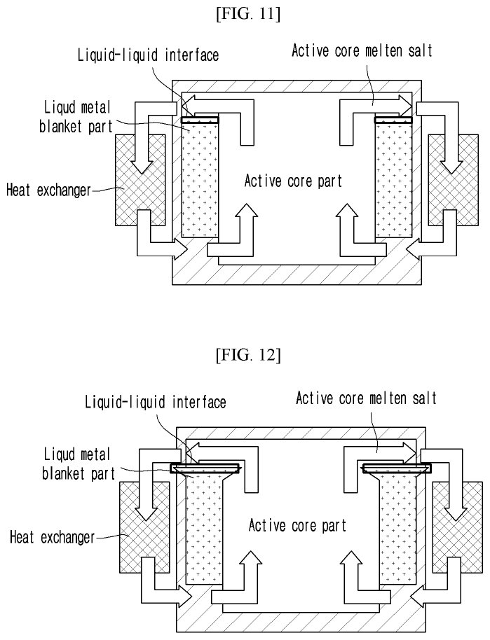

In the molten salt reactor of the present invention, the active core part is disposed to form a liquid-liquid interface with an upper portion of the blanket part that is in the liquid metal phase. That is, in the molten salt reactor of the present invention, the blanket part is provided in the liquid metal phase, unlike the typical molten salt reactor, and the liquid-liquid interface with the active core part is defined on an upper portion of the blanket part. An exemplary structure of the molten salt reactor of the present invention may be more clearly identified through FIGS. 2, 11 and 12. The structure of FIGS. 2, 11 and 12 illustrate one example of the structure of the molten salt reactor of the present invention, and the scope of the claims of the present invention is not limited to the structure of FIGS. 2, 11 and 12.

In the molten salt reactor of the present invention, the fissile fuel is passively supplied from the lower blanket part to the upper active core part through the liquid-liquid interface, and the fertile fuel is passively supplied from the upper active core part to the lower blanket part. That is, the fissile fuel moves from the lower blanket part to the upper active core part through natural circulation based on the liquid-liquid interface existing between the lower blanket part and the upper active core part, and the fertile fuel undergoes a substitution process in which the fertile fuel is transferred from the upper active core part to the lower blanket part.

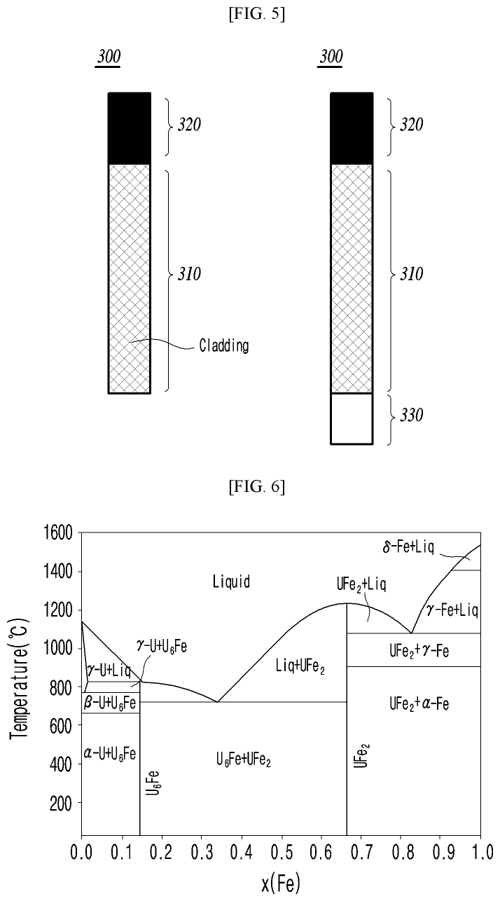

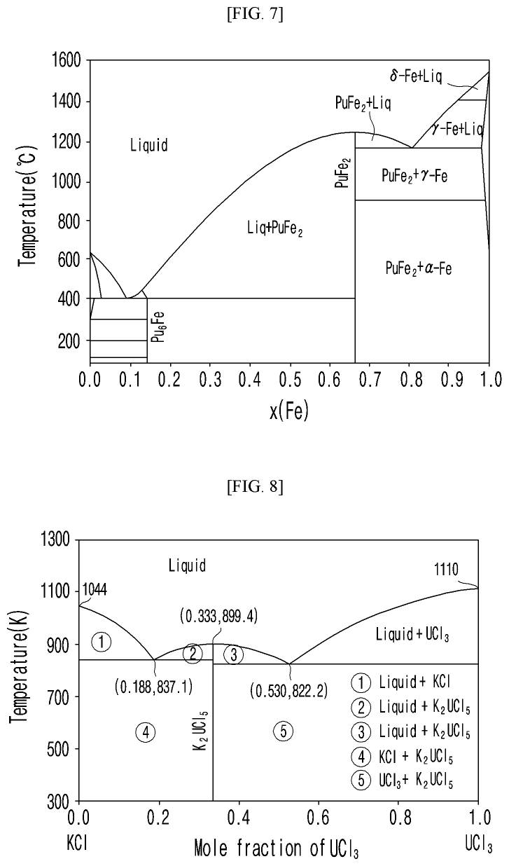

When explaining the above-described contents, as described above, unlike the existing molten salt reactor, the blanket part of the present invention may not be provided by a separate sealed structure but may be located at a lower portion of the molten salt reactor in the liquid metal phase. Thus, the entire top surface of the blanket part may define the liquid-liquid interface in contact with the entire bottom surface of the active core part. The blanket part may be made of iron (Fe) and low-enriched uranium of 5% or less or a natural uranium alloy. To effectively breed the fissile fuel in the blanket part while maintaining a high proportion of U-238, which is the fertile fuel, the uranium in a region of the blanket part has a very low enrichment, and to maintain the liquid state, uranium (U) and iron (Fe) may be contained at a material composition ratio corresponding to a eutectic point of uranium (U) and iron (Fe). The eutectic point refers to mixing conditions of materials where the melting point of the mixture is the lowest, and FIG. 6 illustrates that a eutectic point of U and Fe is about 700° C. with a molar (unit of number of atoms) ratio of U and Fe is about 67:33. FIG. 7 illustrates that a eutectic point of plutonium (Pu) and iron (Fe) is about 400° C. when a molar ratio of Pu and Fe is about 90:10 (FIGS. 5 and 7 are quoted from Moore, E. E. et al., (2019), Development of a CALPHAD thermodynamic database for Pu—U—Fe—Ga alloys, in Applied Sciences, 9(23), 5040).

Alternatively, in the molten salt reactor according to the present invention, the blanket part is provided by a separate structure, disposed in a circumferential direction on an inner surface of the molten salt reactor, and configured so that only a top surface of the blanket part is open to allow an upper portion of the blanket part and the active core part to define a liquid-liquid interface. Due to such a structure, there is an advantage that the breeding efficiency of the fissile fuel using radially leaking neutrons greatly increases while defining the liquid-liquid interface between the blanket part and the active core part, and also, there is an advantage that the radial leakage of the neutrons is prevented from occurring, and gamma rays are effectively shielded.

In the above configuration, the blanket part disposed in the circumferential direction on the inner surface of the molten salt reactor has an open half of a top surface so that an upper portion of the open half and the active core part define the liquid-liquid interface. Here, an area of the open-top surface of the blanket part may be adjusted to control the reaction of the nuclear reactor. For example, as illustrated in FIG. 12, an area of the open top surface of the blanket part may be adjusted to control the speed at which the fissile fuel generated in the blanket part moves to the active core part, and thus, the reaction of the nuclear reactor may be adjusted.

At least one molten salt selected from the group consisting of NaCl, KCl, MgCl₂, UCl₃, PuCl₃, NpCl₃, AmCl₃, and CmCl₃ may be used as the active core molten salt fuel defining the liquid-liquid interface at the upper portion of the blanket, and the present invention may consider a mixture of KCl and UCl₃ under eutectic conditions as an example for the fuel, but in a design of a molten salt fast reactor (MSFR) provided as a double or triple mixed molten salt such as a mixture of NaCl, MgCl₂, and UCl₃, the present invention may also be applied.

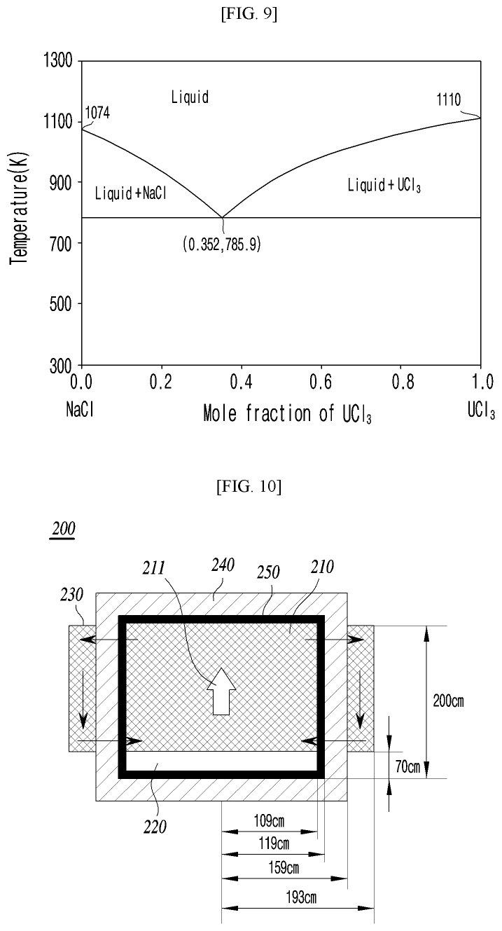

The eutectic points of KCl—UCl₃ and NaCl—UCl₃ are shown at molar ratios of 47:53 and 65:35, respectively, as illustrated in FIGS. 8 and 9 (FIGS. 8 and 9 are quoted from Yin, H. et al., (2020), Thermodynamic description of the constitutive binaries of the NaCl—KCl—UCl₃—PuCl₃ system Calphad, 70, 101783). In the MSFR, the maximum allowable maximum uranium enrichment to be used for the active core fuel is 19.75, and other types of salts such as chlorides or fluorides may be used as molten salt fuel. Most of the neutrons produced by the nuclear fission reaction in the active core region may leak into a region of the blanket part, which is a lower liquid, and the neutrons may be absorbed by U-238, which is the fertile fuel in the region of the blanket part, so that Pu-239, which is the fissile fuel, is bred. Of course, nuclear fission may also occur in the region of the blanket part, and Pu-239, which is that fissile fuel, may also be bred by the neutrons generated in this process.

The Pu-239 fuel grown in the liquid blanket may spontaneously move to the molten salt fuel region of the upper active core due to the chemical reaction caused by a difference in Gibbs free energy (G) difference. The Gibbs free energy is defined as follows and can be represents energy that theoretically extracted from a system under a constant temperature and pressure and is used to predict a direction in which any reaction proceeds spontaneously at a constant temperature and pressure.

$$G = H - TS \qquad ( 1 )$$

In Equation 1, H is an enthalpy, T is a temperature, and S is an entropy

When ΔG is a change in Gibbs free energy before and after a certain chemical reaction, it is indicated that, if ΔG is a positive value, the reverse reaction of the chemical reaction is spontaneous, if ΔG is 0, the reverse reaction of the chemical reaction is equilibrium, and if ΔG is a negative value, the forward reaction is spontaneous. That is, the chemical reaction occurs in a direction in which G decreases.

When fuel depletion occurs in the active core, plutonium is produced in the fuel or blanket as described above. Alternatively, in one embodiment of the present invention, fissile fuels such as Pu-239 and Pu-241 may be already contained before the fuel depletion occurs in the active core, that is, before the operation of a molten salt reactor. The chemical reaction that occurs at an interface between the liquid blanket in which, the plutonium is mainly bred, and the molten salt fuel is as follows.

$$Pu + {UCl}_{3} ↔ U + {PuCl}_{3} \qquad ( 2 )$$

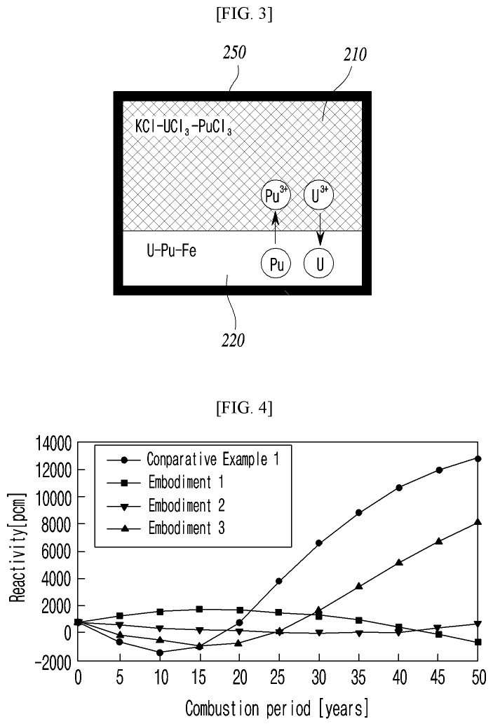

Assuming a temperature of 923 K when the reaction occurs, following Equations: ΔG_{UCl}_{₃}=G_{U}−G_{UCl}_{₃}=−691.6 kJ/mol ΔG_{PuCl}_{₃}=G_{Pu}−G_{PuCl}_{₃}=−772.0 kJ/mol are satisfied, and in the whole system, following Equation ΔG=G_{PuCl}_{₃}−G_{UCl}_{₃}=−80.4 kJ/mol is satisfied. In this reaction, ΔG is a negative value, which means that the system provided as U and PuCl₃ is more stable than the system provided as Pu and UCl₃. Since the forward reaction in the above Equation is a spontaneous reaction, Pu generated in the liquid blanket is ionized into Pu³⁺ to move toward the molten salt, and U³⁺ in the molten salt is reduced into U to move to the liquid blanket. The corresponding content is schematically illustrated in FIG. 3.

Table 1 below shows a potential difference between a metal element and its chlorine-based salt (Table 1 is quoted from Koyama, T. et al., (1997), An experimental study of molten salt electrorefining of uranium using solid iron cathode and liquid cadmium cathode for development of pyrometallurgical reprocessing, Cited in Journal of nuclear science and technology, 34 (4), 384-393). In Table 1, all values are negative values, which means that the salt of the metal is more stable than the metal, and as the value decreases, the tendency of the metal to become a chlorine-based salt may be stronger. As seen from the viewpoint of the Gibbs free energy, since the potential of PuCl₃ has a more negative value than that of UCl₃, it is seen that a substitution reaction between Pu and U is possible in that Pu has the tendency of ionization stronger than that of U.

In Table 1, La, Y, Ce, and the like have a potential less than that of Pu and have a stronger tendency of ionization and thus are preferentially substituted with U to move to the molten salt. Since the above elements are elements that constitute a portion of fission products, it means that, if too many fission products are produced in the liquid blanket, this causes disruption in supplying plutonium to the molten salt. Therefore, output in the liquid blanket may be as low as possible, and this is one of the other reasons for lowering the uranium enrichment in the liquid blanket. On the other hand, the fission products having a potential higher than that of U in Table 1 may be reduced and accumulated in the liquid blanket, and this suggests that the liquid blanket serves to trap insoluble fission products such as so-called noble metals.

TABLE 1

| | 673K | 723K | 773K |
|---|---|---|---|
| Li(I)/Li(0) | | −2.353 | |
| Na(I)/Na(0) | | −2.083 | |
| La(III)/La(0) | −1.914 | −1.868 | −1.821 |
| Y(III)/Y(0) | −1.875 | −1.833 | −1.790 |
| Ce(III)/Ce(0) | −1.867 | −1.821 | −1.774 |
| Nd(III)/Nd(0) | −1.855 | −1.812 | −1.768 |
| Gd(III)/Gd(0) | −1.798 | −1.754 | −1.710 |
| Am(II)/Am(0) | | −1.592 | |
| Pu(III)/Pu(0) | −1.591 | −1.543 | −1.497 |
| Np(III)/Np(0) | −1.472 | −1.434 | −1.390 |
| U(III)/U(0) | −1.274 | −1.233 | −1.190 |
| Zr(II)/Zr(0) | | −0.693 | |
| Cd(II)/Cd(0) | | −0.259 | |
| Fe(II)/Fe(0) | | −0.115 | |

The effect of the Pu—U substitution reaction occurring in the blanket part having the liquid metal phase will be described as follows. If the Pu—U substitution reaction occurs whenever the plutonium is produced in the blanket region, Pu-239 is supplied from the liquid blanket, instead of U-235 being consumed in the molten salt fuel, and additional U-238 is supplied from the molten salt fuel while U-238 is consumed in the liquid blanket. As a result, the reactivity of the MSFR may be optimized to achieve a long lifetime while remaining in a very flat state over the entire reactor lifetime.

As described above, the molten salt reactor according to the present invention defines a blanket part having a liquid metal phase and an active core part defining the liquid-liquid interface at an upper portion of the blanket part. In addition, since the content only pertains to the passive substitution of the fissile fuel and the fertile fuel through the liquid-liquid interface, it may be applied to molten salt reactors of various structures, and specifically, may be applied to a fast spectrum-based molten salt reactor (MSFR) or a fast spectrum-based stable salt reactor (SSR). For example, FIG. 5 illustrates a nuclear fuel rod structure of the typical SSR reactor and a nuclear fuel rod of an SSR reactor including the structure according to the present invention. Insertion and withdrawal of a nuclear fuel assembly during an operation of the SSR reactor have a disadvantage in leading to potential safety limitations. The nuclear fuel rod of the SSR reactor having the structure according to the present invention may be easily applied to the SSR reactor by including the blanket part having a liquid metal phase at a lower end thereof, and the frequency of online reloading may be reduced or excluded by minimizing a change in reactivity through re-supply of fuel. That is, there is an effect that a stable long-term operation is possible without repeated replacement of the fuel rods.

In addition, the present invention includes a process of generating neutrons due to nuclear fission occurring in an active core part of the molten salt reactor, a process of allowing the generated neutrons to move to a blanket part through a liquid-liquid interface, a process of absorbing the neutrons moving to the blanket part into a fertile fuel to generate a fissile fuel inside the blanket part, a process of allowing the generated fissile fuel to move to the liquid-liquid interface through natural circulation inside the blanket part, a process of allowing the fissile fuel moving to the liquid-liquid interface due to the natural circulation to move the active core part through the liquid-liquid interface, and a process of supplying the fertile fuel from the active core part to the blanket part through the liquid-liquid interface.

Hereinafter, the fuel injection method of the present invention will be described in detail. Parts that are not described below are the same as the process performed in the typical molten salt reactor or are omitted because of being obvious from the process.

On the other hand, in the passive fuel injection method of the present invention, when the fissile fuel such as Pu-239 is already contained in the blanket part in the passive fuel injection method, the neutrons generated from the active core part in the injection method may move to the blanket part, and the neutrons may be converted into the fertile fuel to omit the process of generating the fissile fuel.

The active core part of the molten salt reactor contains fissile fuels such as U-235 and Pu-239 to generate the neutrons due to nuclear fission.

A portion of the neutrons generated in this manner moves to the blanket part through the liquid-liquid interface between the active core part and the blanket part of the liquid metal forming the liquid-liquid interface.

The neutrons moving to the blanket part are absorbed by the fertile fuel such as U-238 existing in the blanket part to generate the fissile fuel such as Pu-239. Here, the generated fissile fuel moves to the liquid-liquid interface through natural circulation. Alternatively, in one embodiment of the present invention, fissile fuels such as Pu-239 and Pu-241 may be already contained before the fuel depletion occurs in the active core, that is, before the molten salt reactor operates.

The generated fissile fuel such as Pu-239 moves to the upper active core part through the liquid-liquid interface due to a chemical reaction that occurs due to a difference in Gibbs free energy as described above.

In addition, for the same reason, the fertile fuel such as U-238 existing in the upper active core part is supplied to the blanket part through the liquid-liquid interface.

When the Pu—U substitution reaction occurs while plutonium is generated in a region of the blanket part through the above process, in the active core part containing the molten salt fuel, instead of U-235 being consumed, Pu-239 is supplied from the blanket having a liquid metal phase, and in the blanket part that has the liquid metal phase, U-238 is consumed, and simultaneously, additional U-238 is supplied from the active core part. As a result, there is an effect of achieving a long lifespan while the reactivity of MSFR remains in a very flat state over the entire lifetime of the reactor through the passive fuel injection method.

In the passive fuel injection method of the present invention, the process of generating the nuclear fissile fuel by absorbing the neutrons generated by the nuclear fission in the blanket part by the fertile fuel in the blanket part may be further performed. That is, not only the neutrons generated by the nuclear fission in the active core part but also the neutrons generated by the nuclear fission of the fissile fuel such as U-235 and Pu-239 in the blanket may be absorbed into U-238, which is the fertile fuel, to generate Pu-239.

In this case, in the passive fuel injection method of the present invention, some of the fissile fuel generated in the blanket part may move to the active core part through the liquid-liquid interface. A substitution rate varies depending on a ratio of a surface area to a blanket volume, and the range of the preferred substitution rate varies depending on the characteristics of a designed core. A reaction rate per unit area of the substitution reaction is determined physically and chemically, and since exact numerical values thereof are not provided, an effect of the present invention will be confirmed through the following three experimental examples.

### EMBODIMENTS OF THE INVENTION

Hereinafter, the present invention will be described in more detail through experimental examples. However, the following description is intended only to describe the present invention in detail and to see the effects thereof, and is not intended to be interpreted as the scope of the present invention is limited by the contents described below.

### Experimental Example

To confirm the effect of the substitution reaction of the liquid blanket and the molten salt fuel on the change in reactivity, a computational calculation was performed using Serpent 2, which is a Monte Carlo-based core analysis code. A conceptual view of the MSFR used in the calculation is illustrated in FIG. 10, where its heat output is about 300 MWth. The inner radius of the reactor vessel was about 109 cm, the thickness of the reactor vessel was about 10 cm, and a thickness of a stainless steel-based reflector was about 40 cm. Here, a volume of an inactive core including a heat exchanger was the same as a volume of an active core. It was assumed that the height of the core was about 200 cm, and the height of the liquid blanket was about 70 cm, and a core analysis was performed assuming that inlet and outlet temperatures of the molten salt were about 600° C. and about 700° C., respectively.

According to the result, when the substitution reaction between Pu—U does not occur was conceived as a comparative example, a case in which 100% of Pu produced in the blanket portion of the liquid metal phase is substituted with U of an upper molten salt region (Example 1), a case in which only 50% is substituted (Example 2), and a case in which only 20% is substituted (Example 3) were assumed. Although considered three Pu—U substitution rates may differ from those of the actual chemical reactions, whether the reactivity is flattened due to the Pu—U substitution reaction alongside the possibility of the long-term operation of the reactor may be evaluated.

FIG. 4 illustrates the change in reactivity when the above MSFR operates for about 50 years with a power of about 300 MW. When the fuel substitution of FIG. 4 does not occur (Comparative Example 1), it is observed that the reactivity initially decreases slowly during about 10 years and increases significantly after about 10 years. While U-235, which is the fissile material, steadily decreases in the molten salt fuel region of the active core for the early about 10 years, the decrease in reactivity is caused because Pu-239 breeding does not occur sufficiently in the entire core including the liquid blanket region. However, after about 10 years, the breeding of Pu-239 in the blanket area increases rapidly, and as a result, the output of the blanket area also increases, resulting in an excessive increase in the reactivity of the core. As a result, in case of the absence of Pu—U substitution, the lifespan of the core is very short about 2 years.

When the Pu—U substitution occurs between the blanket and the molten salt, the change in reactivity of the core is greatly changed as illustrated in FIG. 4. Referring to the reactivity when the Pu—U fuel substitution is about 100% (Example 1) and when the fuel substitution is about 50% (Example 2), it is confirmed that the reactivity is in the range of around 2,000 pcm for a long period of time when compared to a case in which the fuel substitution does not occur. Particularly, when only about 50% of Pu-239 grown in the blanket is substituted (Example 2), it is seen that the change in reactivity for about 50 years is very small, and an ultra-long lifespan of about 50 years or more is substantially achieved. The change in reactivity means that whenever fuel is consumed in the upper molten salt, the fuel supply from the lower blanket is properly performed. As a result, it is seen that the MSER operation is possible in an extremely safe, stable and efficient manner by supplying a portion of Pu grown in the liquid fuel blanket region to the upper active core based on a passive chemical reaction.

What is claimed is:

1. A molten salt reactor comprising an active core part and a blanket part,
wherein the active core part is disposed to define a liquid-liquid interface with an upper portion of the blanket part having a liquid metal phase, and
a fissile fuel is passively supplied from a lower blanket part to an upper active core part through the liquid-liquid interface, and a fertile fuel is passively supplied from the upper active core to the lower blanket part.

2. The molten salt reactor of claim 1, wherein an entire top surface of the blanket part defines the liquid-liquid interface with an entire bottom surface of the active core part.

3. The molten salt reactor of claim 1, wherein the blanket part is disposed in a circumferential direction on an inner surface of the molten salt reactor, and
only a top surface of the blanket part is open so that an upper portion of the blanket part and the active core part define the liquid-liquid interface.

4. The molten salt reactor of claim 3, wherein an area of an open top surface of the blanket part is adjusted to control a reaction of the nuclear reactor.

5. The molten salt reactor of claim 1, wherein the active core part comprises at least one molten salt selected from the group consisting of NaCl, KCl, MgCl₂, UCl₃, PuCl₃, NpCl₃, AmCl₃, and CmCl₃.

6. The molten salt reactor of claim 1, wherein uranium enrichment of the active core part is about 19.75 or less.

7. The molten salt reactor of claim 1, wherein the blanket part comprises an alloy of iron and 5% or less of low-enriched uranium or natural uranium.

8. The molten salt reactor of claim 7, wherein the blanket part comprises iron and uranium corresponding to a eutectic point of iron and uranium.

9. The molten salt reactor of claim 1, wherein the blanket part already contains fissile fuel before the molten salt reactor operates.

10. The molten salt reactor of claim 1, wherein a fissile fuel passively supplied to the upper active core part through the liquid-liquid interface due to natural circulation in the lower blanket part comprises Pu-239, and
the fertile fuel passively supplied from the upper active core part to the lower blanket part comprises U-238.

11. The molten salt reactor of claim 1, wherein the passive supply of the fissile fuel and the fertile fuel is performed by a chemical reaction that occurs due to a difference in Gibbs free energy.

12. The molten salt reactor of claim 1, wherein the molten salt reactor comprises a fast spectrum-based molten salt reactor (MSFR) or a fast spectrum-based stable salt reactor (SSR).

13. A passive fuel injection method comprising:
generating neutrons due to nuclear fission occurring in an active core part of the molten salt reactor of claim 1;
allowing the generated neutrons to move to a blanket part through a liquid-liquid interface;
absorbing the neutrons moving to the blanket part into a fertile fuel to generate a fissile fuel inside the blanket part;
allowing the generated fissile fuel to move to the liquid-liquid interface through natural circulation inside the blanket part;
allowing the fissile fuel to move to the liquid-liquid interface due to the natural circulation to move the active core part through the liquid-liquid interface; and
supplying the fertile fuel from the active core part to the blanket part through the liquid-liquid interface.

14. The passive fuel injection method of claim 13, further comprising the absorption of nuclear fission-born neutrons in the blanket part transmuting fertile fuel within the blanket part to fissile fuel.

15. The passive fuel injection method of claim 13, wherein the allowance of the fissile fuel to move to the active core part through the liquid-liquid interface and the supplying of the fertile fuel from the active core part to the blanket part through the liquid-liquid interface are passively performed by a chemical reaction caused by a difference in Gibbs free energy.

16. The passive fuel injection method of claim 13, wherein the blanket part contains the fissile fuel before the fissile fuel is generated by the neutrons moving from the active core part.
